(19) United States
(12) Patent Application Publication
(10) Pub. No.: US 2007/0211344 A1
(43) Pub. Date: Sep. 13, 2007

(54) Half mirror

(75) Inventor: Kazutoshi Setoguchi, Miyazaki-shi (JP)

Correspondence Address: OLIFF & BERRIDGE, PLC, P.O. BOX 19928, ALEXANDRIA, VA, 22320, US

(73) Assignee: EPSON TOYOCOM CORPORATION, TOKYO (JP)

(21) Appl. No.: 11/712,489

(22) Filed: Mar. 1, 2007

(30) Foreign Application Priority Data
Mar. 10, 2006 (JP) 2006-065229

(51) Int. Cl. G02B 1/10

(52) U.S. Cl. 359/582; 359/584; 359/577

(57) ABSTRACT

A half mirror comprises: a beam splitter coating formed on one main surface of a transparent substrate; an anti-reflection coating formed on the other main surface; and a correction coating having substantially the same refractive index as that of the transparent substrate is formed between the transparent substrate and the anti-reflection coating so that a warpage of the transparent substrate caused by a stress of the beam splitter coating is corrected by a stress of the correction coating.

### BACKGROUND

1. Technical Field

The present invention relates to a half mirror that is used in a component such as an optical pickup of an optical-disk recording/reproducing device, the half mirror being particularly suitable for preventing deterioration of optical characteristics such as wavefront aberration.

2. Related Art

Half mirrors having the characteristics to reflect incident lights and transmit part of the incident lights are widely used in the optical pickups of such devices as optical-disk recording/reproducing devices.

An optical element such as the mentioned half mirror is composed of various types of optical coating formed on a substrate such as a glass substrate. However, as shown in FIG. 2A, when an optical coating (a thin film) 52 is formed on one main surface 51a of a glass substrate 51, a stress is generated at the one main surface 51a side of the glass substrate 51 because, for example, the glass substrate 51 and the optical coating 52 have different thermal expansion coefficients. At this point, if the stress generated at the main surface 51a side of the glass substrate 51 is a tensile stress, a recessed warpage occurs at the main surface 51a side of the glass substrate 51 as shown in FIG. 2B. In contrast, if the stress generated at the main surface 51a of the glass substrate 51 is a compressive stress, a projecting warpage occurs at a main surface 51b of the glass substrate 51 as shown in FIG. 2C. As a consequence, there arises a problem that the wavefront aberration of the optical element deteriorates and that the desired optical characteristics are not satisfied.

Therefore, in order to reduce the deterioration of the wavefront aberration, a conventional half mirror 60 includes, as shown in FIG. 3A, a beam splitter coating (hereinafter referred to as BS coat) 62 formed on one main surface 61a of a glass substrate 61 and an anti-reflection coating (hereinafter referred to as AR coat) 63 formed on the other main surface 61b.

In this case, because the stresses of the BS coat 62 and AR coat 63 are both compressive stresses, the BS coat 62 and AR coat 63 are formed on the respective main surfaces 61a and 62b of the glass substrate 61, thereby canceling each other's stresses and preventing the warpage of the glass substrate 61.

JP-A-2005-43755 discloses an optical multilayer coating filter that is prevented from optical distortion by reducing a warpage of a substrate caused by the stress of the dielectric thin films stacked on the transparent substrate.

Further, JP-A-7-209516 discloses an optical multilayer coating filter in which the stress and warpage of the coating can be reduced as compared with a conventional optical multilayer coating filter even if the number of the layers of the dielectric multilayer coating is 40 or more.

The stress generated upon formation of the BS coat 62 or the AR coat 62 on the glass substrate 61 depends on the thickness of the coating. If the half mirror 60 is composed as shown in FIG. 3A, however, the thickness of the BS coat 62 becomes about 2 μm, and the thickness of the AR coat 63 becomes about 0.5 μm, the difference of the two becoming large. Therefore, even if the BS coat 62 is formed on the one main surface 61a of the glass substrate 61, and the AR coat 63 is formed on the other main surface 61b, the projecting warpage occurs at the BS coat 62 side of the glass substrate 61 due to the stress difference caused by the difference in coating thicknesses.

As a result, there arises a problem that the wavefront aberration of the optical element deteriorates and that the conventional half mirror does not satisfy the desired optical characteristics.

### SUMMARY

An advantage of the invention is to provide a half mirror that satisfies the desired characteristics without the deterioration of the wavefront aberration.

According to an aspect of the invention, a half mirror having a beam splitter coating formed on one main surface of a transparent substrate and an anti-reflection coating formed on the other main surface, in that: a correction coating having substantially the same refractive index as that of the transparent substrate is formed between the transparent substrate and the anti-reflection coating so that a warpage of the transparent substrate caused by a stress of the beam splitter coating is corrected by a stress of the correction coating.

With this composition, the stress of the beam splitter coating formed on one main surface of the transparent substrate and the stress of the anti-reflection coating formed on the other main surface may be balanced out by the stress of the correction coating formed on the other main surface of the transparent substrate. As a result, it becomes possible to correct the warpage of the transparent substrate and to thereby obtain a half mirror satisfying the desired characteristics without the deterioration of the wavefront aberration.

It is preferable that the transparent substrate be a white plate glass, and the correction coating be a SiO₂ coating. In this case, because the refractive index of the transparent substrate may become substantially the same as that of the correction coating, it is possible to minimize the deterioration of the wavefront aberration caused by the difference in refractive indexes between the transparent substrate and the correction coating.

### BRIEF DESCRIPTION OF THE DRAWINGS

The invention will be described with reference to the accompanying drawings, wherein like numbers reference like elements.

FIG. 1 is a cross-sectional diagram showing the composition of a half mirror according to an embodiment of the invention.

FIGS. 2A through 2C are diagrams to explain stresses generated when an optical coating is formed on a glass substrate.

FIGS. 3A through 3C are cross-sectional diagrams showing the composition of a conventional half mirror.

### DESCRIPTION OF EXEMPLARY EMBODIMENT

Embodiment of the invention will now be described.

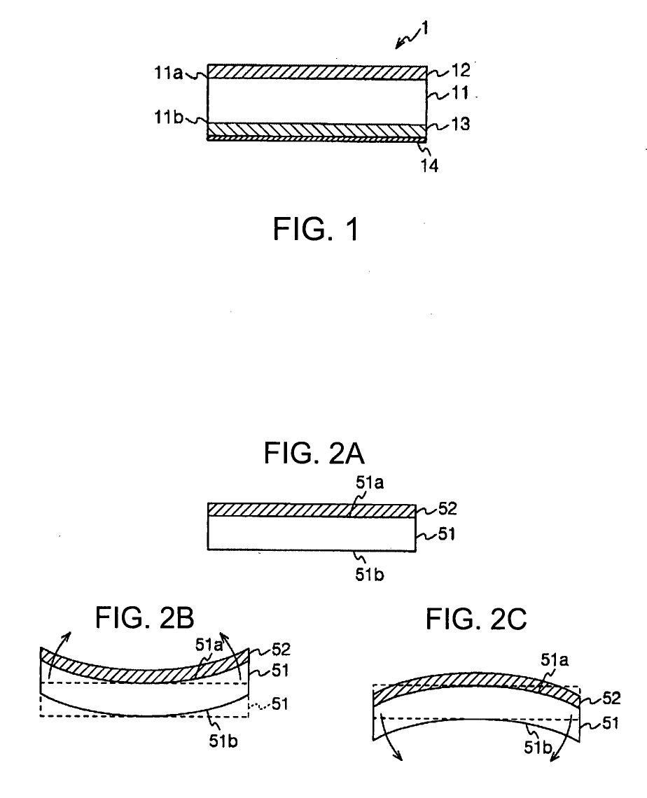

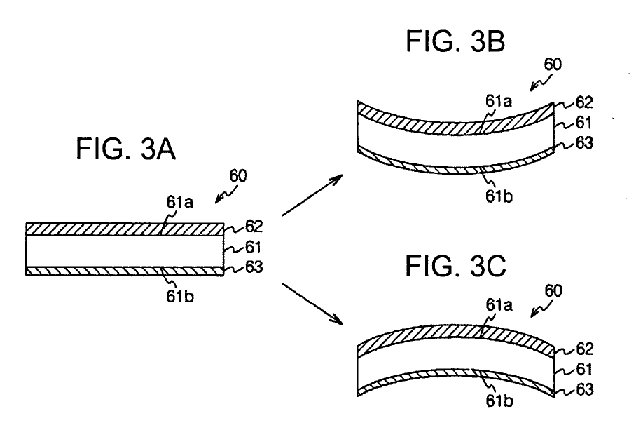

FIG. 1 is a cross-sectional diagram showing the composition of a half mirror according to an embodiment of the invention.

A half mirror 1 of the embodiment as shown in FIG. 1 includes a BS coat 12, which is a beam splitter coating, on one main surface 11a of a transparent substrate 11 and a correction coating 13 on the other main surface 11b of the transparent substrate 11. It is characteristic of this composition that, by forming an AR coat which is an anti-reflection coating on this correction coating 13, the stress of the correction coating 13 cancels and balances out the stresses generated at both main surfaces 11a and 11b of the transparent substrate 11, thereby preventing the warpage from occurring in the transparent substrate 11.

A warpage δ of a substrate can be expressed in a relation with a coating thickness D as shown in a formula (1) below. Accordingly, the quantity of correction can be adjusted as desired by the thickness of the correction coating 13.

σ=Ex×B̂2×δ/3(1−νs)×D×L̂2 (1)

where σ is a coating stress; Es is a Young's modulus of the substrate; B is a thickness of the substrate; δ is a displacement (warpage) at the tip of the substrate; νs is a Poisson's ratio of the substrate; L is a length of the substrate; and D is a thickness of the coating.

For example, it is assumed here that the thickness of the BS coat 12 formed on the main surface 11a of the transparent substrate 11 is about 2 μm, and that the thickness of the AR coat 14 formed on the main surface 11b of the transparent substrate 11 is about 0.5 μm. Also, it is assumed that the stresses of the BS coat 12 and AR coat 14 are both compressive stresses. Then, in the embodiment, the correction coating 13 having the compressive stress between the transparent substrate 11 and the AR coat 14 is to be formed in a thickness of about 1.5 μm. The assumptions are so made that the stresses generated at the main surfaces 11a and 11b of the transparent substrate 11 shall cancel each other and become balanced out.

Further, the correction coating 13 in this case is composed of a coating material having substantially the same refractive index as that of the transparent substrate 11 so as not to impede the optical characteristics. For example, if the white plate glass (refractive index=1.52) is used for the transparent substrate 11, the correction coating 13 is formed using a SiO₂ coating (refractive index=1.46) whose refractive index is close to that of the white plate glass.

Additionally, instead of the white plate glass, other substrate such as a SiO₂ substrate having a refractive index of 1.46 or a borosilicate crown glass (BK7) having a refractive index of 1.51 may be used for the transparent substrate 11.

Further, if the coating material of the BS coat 12 has the tensile stress instead of the compressive stress, the correction coating 13 may be made of a coating material having the tensile stress, such as an Al₂O₃ coating (refractive index=1.62) or a MgF₂ coating (refractive index=1.38), for example.

As thus described, the embodiment is the half mirror 1 having the BS coat 12 on one main surface 11a side of the transparent substrate 11 and the AR coat 14 on the other main surface 11b side, in that the correction coating 13 having substantially the same refractive index as that of the transparent substrate 11 is formed between the transparent substrate 11 and the AR coat 14 coating so that the warpage of the transparent substrate 11 caused by the stress of the BS coat 12 is corrected by the stress of the correction coating 13. As a consequence, by balancing out the stress of the BS coat 12 formed on the main surface 11a of the transparent substrate 11 and the stresses of the correction coating 13 and AR coat 14 formed on the main surface 11b of the transparent substrate 11 by use of the stress of the correction coating 13 formed on the main surface 11b of the transparent substrate 11, it becomes possible to correct the warpage of the transparent substrate 11. As a result, according to the embodiment, it is possible to obtain the half mirror 1 that satisfies the optical characteristics of the optical pickup of a device such as the optical-disk recording/reproducing device without the deterioration of the wavefront aberration.

Additionally, if the transparent substrate 11 is composed of the white plate glass, and the correction coating is composed of the SiO₂ coating, the refractive index of the transparent substrate 11 becomes substantially the same as that of the correction coating 13, and, thus, it is an advantage that the deterioration of the optical characteristics caused by the difference in refractive indexes between the transparent substrate 11 and the correction coating 13 can be minimized.

What is claimed is:

1. A half mirror comprising:
a beam splitter coating formed on one main surface of a transparent substrate;
an anti-reflection coating formed on the other main surface; and
a correction coating having substantially the same refractive index as that of the transparent substrate is formed between the transparent substrate and the anti-reflection coating so that a warpage of the transparent substrate caused by a stress of the beam splitter coating is corrected by a stress of the correction coating.

2. The half mirror according to claim 1, wherein the transparent substrate is a white plate glass, and the correction coating is a SiO₂ coating.
